(19) United States
(12) Patent Application Publication
(10) Pub. No.: US 2007/0036659 A1
(43) Pub. Date: Feb. 15, 2007

(54) Method of manufacturing a wind turbine blade, wind turbine blade, front cover and use of a front cover

(75) Inventor: Paul Hibbard, Southampton (GB)

Correspondence Address: CANTOR COLBURN, LLP, 55 GRIFFIN ROAD SOUTH, BLOOMFIELD, CT, 06002, US

(73) Assignee: VESTAS WIND SYSTEMS A/S, Ringkobing (DK)

(21) Appl. No.: 10/547,514

(22) PCT Filed: Feb. 28, 2003
(86) PCT No.: PCT/DK03/00131

§ 371 Date: Oct. 17, 2006

(51) Int. Cl. B64C 11/24

(52) U.S. Cl. 416/233

(57) ABSTRACT

The invention relates to a method of manufacturing a wind turbine blade, said method comprising the steps of: casting at least two wind turbine shells and preferably one or more load bearing structures, forming a wind turbine blade structure including at least two longitudinal joints by adhering said at least two wind turbine shells and said one or more load bearing structures together, forming one or more front covers to a shape substantially corresponding to said wind turbine blade structure or sections hereof, positioning said one or more front covers in relation to said wind turbine blade structure, and fastening said one or more front covers to said wind turbine blade structure with adhering means. The invention also relates to a wind turbine blade, front cover and the use of a front cover as a unit for supplementary mounting on a wind turbine blade.

### BACKGROUND OF THE INVENTION

The invention relates to a method of manufacturing a wind turbine blade, a wind turbine blade according to the preamble of claim 10, a front cover according to the preamble of claim 19 and use of a front cover.

### DESCRIPTION OF THE RELATED ART

Modern wind turbines usually comprise a rotor with a considerable diameter size, as illustrated in FIG. 1. The wind turbine blades for modern wind turbines are approaching lengths of 50 metres and more.

In order to create wind turbine blades that are capable of withstanding the significant forces of the wind as well as their own weight, the blades are constructed with two glass fibre shells and one or more internal glass fibre load-bearing beams, ribs etc., all adhered to each other.

The wind turbine blades have to undergo an aftertreatment, as the surface of the wind turbine shells needs smoothing so that the wind will not be slowed down or make any noise when it moves across the surface of the blades. All shell joints, scratches and cavities have to be filled with gelcoat or similar filling materials. Finally, the blades are grounded and polished until they are completely smooth.

However, the abovementioned aftertreatment methods of manufacturing wind turbine blades all have disadvantages.

Especially, they consume a disproportionate amount of manpower, demanding significant amount of space and specialized systems.

Further, they are demanding in time and expertise, during construction as well as in latter quality control procedures.

The object of the invention is to establish wind turbine blades without the above-mentioned disadvantages.

Especially, it is an object of the invention to establish ways of constructing wind turbine blades without aftertreatment involving time consuming processes eventually leading to an increase in the costs of the blades.

### THE INVENTION

In accordance with the invention, a method of manufacturing a wind turbine blade, said method comprising the steps of:
casting at least two wind turbine shells and preferably one or more load bearing structures,
forming a wind turbine blade structure including at least two longitudinal joints by adhering said at least two wind turbine shells and said one or more load bearing structures together,
forming one or more front covers to a shape substantially corresponding to said wind turbine blade structure or sections hereof,
positioning said one or more front covers in relation to said wind turbine blade structure, and
fastening said one or more front covers to said wind turbine blade structure with adhering means.

Hereby it is possible to control sections of the wind turbine blade surface with one or more easily controllable and constructible front covers.

Especially, it is easy to establish a wind turbine blade with a smooth surface at the parts that are particularly important in creating advantageous flow over the surfaces such as the front or leading section of the wind turbine blade.

In the construction of the wind turbine blade it is thus not necessary to involve aftertreatment comprising time-consuming processes eventually leading to an increase in the costs of the blades such as grounding and polishing.

It shall be emphasized that with the term “front cover” is meant a cover that is situated as a surface to the wind turbine blade or sections hereof, and thus establishing a new front at the covering position.

When, as stated in claim 2, said one or more covers are positioned above one of said at least two longitudinal joints or a section hereof, an advantageous embodiment of the invention has been achieved.

As the joint of the wind turbine blade is covered with the front cover the constructing of the wind turbine blade does not need to involve any further aftertreatment in relation to the joint.

When, as stated in claim 3, said adhering means is applied to the inner surface of said one or more front covers and to said wind turbine blade structure such as one or more corresponding sections of said wind turbine blade structure before fastening said one or more front covers to said wind turbine blade structure, it is possible to establish an advantageous and simple method of fitting a front cover to a wind turbine blade.

When, as stated in claim 4, said fastening comprises the steps of: provisionally fastening said one or more front covers to said wind turbine blade structure, closing one or more space openings between said one or more front covers and said wind turbine blade structure or mutually between two or more of said one or more front covers, and filling said space with adhesive means in form of an adhesive mass, it is possible

When, as stated in claim 5, said space is created by using distance means expanding from the inner surface of said one or more front cover, it is possible to establish a well-defined space. The well-defined space ensures the correct adhering of the front cover to wind turbine blade resulting in perfectly shaped wind turbine blades and front covers.

When, as stated in claim 6, said closing of space openings involves positioning of internal or external adhering means at the longitudinal and/or transverse edges of said one or more front covers, a fully closed space is established ensuring that the aftertreatment is diminished in relation to removal of any surplus adhering mass.

When, as stated in claim 7, said closing involves engaging or locking the adjacent front covers to each other, it is possible to establish the closed space without taking any measures in relation to the crossings between the front covers as the engaging or locking will be sufficient close-fitting. Further, the engaging or locking of one front cover to the next makes it easier to position the front covers on the wind turbine blade as one front cover takes the next.

When, as stated in claim 8, silicone mass, expander foam or the like is used to close openings between the front cover and the wind turbine blade or between the adjacent front covers, it is possible to close the crossings between the adjacent front covers establishing one space underneath each front cover. With one space underneath every front cover it is easier to ensure a more tailored filling of each space.

When, as stated in claim 9, said adherent means is applied or injected as a mass with a high fluidity at time of injection, it is possible to fill even quite large spaces. Especially, it is preferred that any corner of the space is filled without using high pressure pumping. Further, it will be possible to lift one end of the blade allowing the mass to flow totally or partly by force of gravity.

The invention also relates to a wind turbine blade comprising one or more front covers covering the surface of said blade or sections hereof and being adhered to the surface with adhesive means, wherein said one or more front covers being pre-formed to a shape substantially corresponding to said wind turbine blade or sections hereof.

In relation to flow it is hereby possible to create an advantageous wind turbine blade with a particular smooth surface at important parts of the blade.

When, as stated in claim 11, one or more front covers partly or totally cover one or more of said at least two substantially longitudinal joints, it is possible to achieve an advantageous embodiment of the invention.

As the joint of the wind turbine blade is covered with the front cover the constructing of the wind turbine blade does not need to involve any further aftertreatment in relation to the joint.

When, as stated in claim 12, one or more distance means expand from the inner surface of said one or more front covers and adhesive means fill the space between said one or more front covers and said wind turbine blade, it is possible to establish an advantageous embodiment of the invention.

When, as stated in claim 13, said adhesive means is a mass with high fluidity at the time of application or injection, an advantageous embodiment of the invention has been achieved especially as any area of the space may be filled will adhesive mass.

When, as stated in claim 14, said adhesive means is a one or two-component adhesive such as epoxy, polyurethane or methacrylate adhesives, it is possible to create a bonding particularly durable in relation to the different kind of weather conditions a wind turbine blade is exposed to.

When, as stated in claim 15, said front covers continuously or substantially cover said blade from root to tip, it is possible to establish a similar flow over the different parts of the wind turbine blade.

When, as stated in claim 16, the end of the front covers overlap, it is possible to establish a similar flow over the wind turbine blade and at the same time establish a closed space underneath the front covers for the adhesive mass.

When, as stated in claim 17, said front cover ends comprise engaging or locking means such as an inner and outer edge or rim and/or adhesive means, it is possible to establish a closed space without taking any measures in relation to the crossings between the front covers as the engaging or locking will be sufficient close-fitting.

When, as stated in claim 18, tape or strips connect and close said adjacent ends or crossings between said ends, it is possible to close the crossings in an easy manner. Especially, as the positioning of the front covers in relation to each other becomes less important being covered by tape in the crossing. After the filling and curing of the adhesive mass the tape may be removed—if necessary.

Further, the invention also relates to a front cover comprising
a centre section and at least two cover flap sections,
wherein said front cover partly or totally is pre-formed to a shape substantially corresponding to a wind turbine blade or sections hereof.

Hereby it is possible to establish a front cover with a smooth and well-defined surface to cover a section of the wind turbine blade.

When, as stated in claim 20, said cover being adequately of substantially covering one or more longitudinal joints of said wind turbine blade or sections hereof, an advantageous embodiment of the invention has been achieved.

When, as stated in claim 21, said cover being adequately of substantially covering the leading joint of said wind turbine blade, an advantageous embodiment of the invention has been achieved.

When, as stated in claim 22, the inner and outer surfaces of said cover are smooth or substantially smooth, it is possible to establish a cover that is easy to mount on the blade due to the direct encircling of the blade. Further, the front cover and the blade are only separated by the adhesive means establishing a direct and strong bonding between the two.

When, as stated in claim 23, the inner surface of said cover comprises one or more distance means, it is possible to establish a well-defined space in connection with a wind turbine blade. The well-defined space ensures the correct adhering of the front cover to wind turbine blade resulting in perfectly shaped wind turbine blades and front covers.

When, as stated in claim 24, the ends of said one or more distance means are pre-defined to a shape corresponding to the shape of said wind turbine blade such as the shape of the leading edge, it is possible directly to arrange the front cover on the blade.

When, as stated in claim 25, said one or more distance means are positioned symmetrically in relation to said one or more longitudinal joints, e.g. on the joint or on opposite side of a joint at the same distance from the joint, it is possible to position the front cover more exactly in relation to the wind turbine blade and the joint.

When, as stated in claim 26, said one or more distance means comprise shapes of oblong bars, cones, triangles, rectangles, cylinders, hemispheres or other similar shapes, advantageous embodiments of the invention are achieved.

When, as stated in claim 27, said one or more distance means comprise patterns of distance means such as patterns including symmetrically positioned distance means in relation to a centreline of the front cover or said one or more longitudinal joints of said wind turbine blade, the front cover may be positioned more exactly e.g. in relation to the subsequent adhering of the flap sections on the wind turbine blade.

When, as stated in claim 28, said one or more distance means comprise patterns of distance means including different shaped distance means, it is possible to adapt the front cover to a given type of wind turbine blade or to different sections of a wind turbine blade, e.g. sections being different in size such as in width or height.

When, as stated in claim 29, the front cover thickness ranges between 0.1 and 5 millimetres preferably between 0.5 and 3 millimetres, e.g. 0.5 millimetre at the cover flap sections and 1.5 millimetres at the centre of the front cover, it is possible to establish a durable but still flexible and light front cover. The flexibility is especially advantageous if bending of the flap sections toward the wind turbine blade is necessary.

When, as stated in claim 30, the cover length ranges between 1 and 100 metres preferably between 1 and 5 metres such as 2 metres, it is possible to establish front covers which are easy to handle and work with during mounting of the front covers.

When, as stated in claim 31, said distance means comprise a length between 0.5 and 8 millimetres such as 3 millimetres, it is possible to establish a well-defined space in connection with a wind turbine blade.

When, as stated in claim 32, said cover comprises a width and height corresponding to the blade shape, e.g. ranging between 0.1 and 5 metres in width such as between 0.02 and 0.2 metre and between 0.1 and 2 metres in height such as between 0.05 and 0.2 metre, front covers may be established that fit modern wind turbine blades of significant lengths.

When, as stated in claim 33, said front cover is made in glass fibre material or a similar fibre material such as carbon or aramid fibre material reinforcing an epoxy or polyester resin, plastic material or combinations of the mentioned materials, a preferred embodiment of the front cover has been achieved. Especially, as the front cover is both resilient to weather conditions, durable, light weighted and cost efficient.

When, as stated in claim 34, said front cover being made in a metal plate material such as aluminium or similar light metal plates with welded or adhered distance means, a durable embodiment of the front cover has been achieved.

When, as stated in claim 35, the inner surface of said front cover and preferably the inner surface of said at least two cover flap sections comprise at least one adhesive layer, it is possible to adhere the front covers to the wind turbine blade in an easy and reliable manner.

When, as stated in claim 36, said at least one adhesive layer comprises a width in a range of 10 and 100 millimetres such as 50 millimetres, it is possible to fasten the front cover securely enough to maintain the closed space during injection of adhesive mass.

When, as stated in claim 37, the ends of the front cover comprise means for engaging or locking with the adjacent front cover such as an inner edge or rim in one end of the cover and outer edge or rim at the other end and/or adhesive means, an advantageous engaging or locking possibility has been achieved between the front covers.

When, as stated in claim 38, the ends of the front cover comprise means for engaging or locking with the adjacent front cover such as tape or strips connecting and closing said adjacent ends or crossings between said ends, it is possible to close the adjacent ends or crossings in an easy manner.

Even further, the invention also relates to a front cover used as a unit for supplementary mounting on a wind turbine blade. Hereby, it is possible to arrange front covers on blades being part of erected and operational wind turbines. The front cover arrangement may preferably be performed in relation with the repair of blades comprising surface damage e.g. from hailstorms, sand storms, strokes of lightning or birds.

The repair may take place at the position of the wind turbine with or without dismounting the blades from the wind turbine.

### FIGURES

The invention will be described in the following with reference to the figures in which

FIG. 1. illustrates a large modern wind turbine,

FIG. 2 illustrates a preferred embodiment of a wind turbine blade including front covers according to the invention,

FIG. 3 illustrates a sectional view of the preferred embodiment in FIG. 2,

FIG. 4 illustrates a preferred embodiment of a front cover according to the invention,

FIGS. 5a to 5d illustrate the linking between several, front covers including different examples of connections between opposite edges of the covers,

FIG. 6 illustrates an exploded view of a preferred embodiment of a wind turbine blade including front covers according to the invention,

FIGS. 7a to 7c illustrate a first method of manufacturing a wind turbine blade including a first embodiment of a front cover according to the invention,

FIGS. 7d to 7f illustrate a second method of manufacturing a wind turbine blade including a second embodiment of a front cover according to the invention,

FIGS. 7g and 7h illustrate a third method of manufacturing a wind turbine blade including a third embodiment of a front cover according to the invention,

FIG. 8 illustrates a flow chart of the manufacturing of a wind turbine blade including a preferred embodiment of a front cover according to the invention,

FIGS. 9a to 9d illustrate different embodiments and patterns of distance means on the inner surface of the front cover,

FIG. 10 illustrates different embodiments of the distance means seen from the side,

FIG. 11 illustrates further embodiments of the distance means seen from the side, and

FIGS. 12a to 12c illustrate another preferred embodiment of the front cover according to the invention.

### DETAILED DESCRIPTION

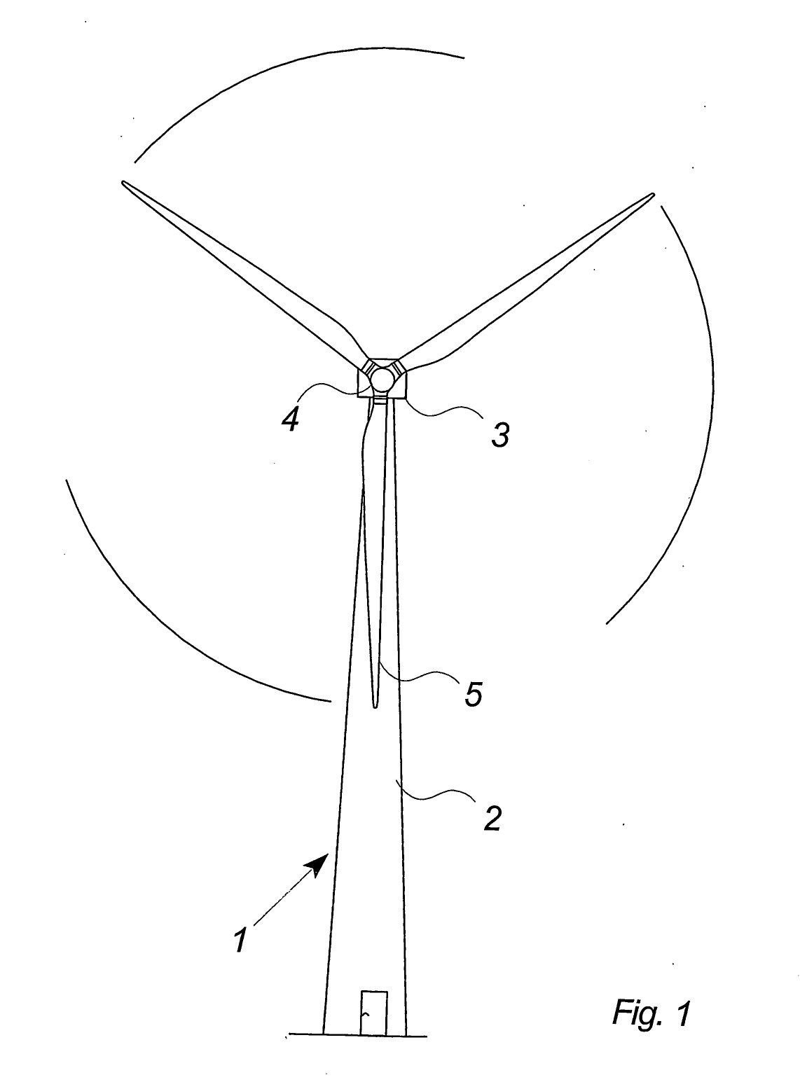

FIG. 1 illustrates a modern wind turbine 1 with a tower 2 and a wind turbine nacelle 3 positioned on top of the tower. The wind turbine rotor, comprising three wind turbine blades 5, is connected to the nacelle through the low speed shaft, which extends out of the nacelle front.

As illustrated in the figure, wind beyond a certain level will activate the rotor due to the lift induced on the blades and allow it to rotate in a perpendicular direction to the wind. The rotation movement is converted to electric power, which is usually supplied to the transmission grid as known by skilled persons within the area.

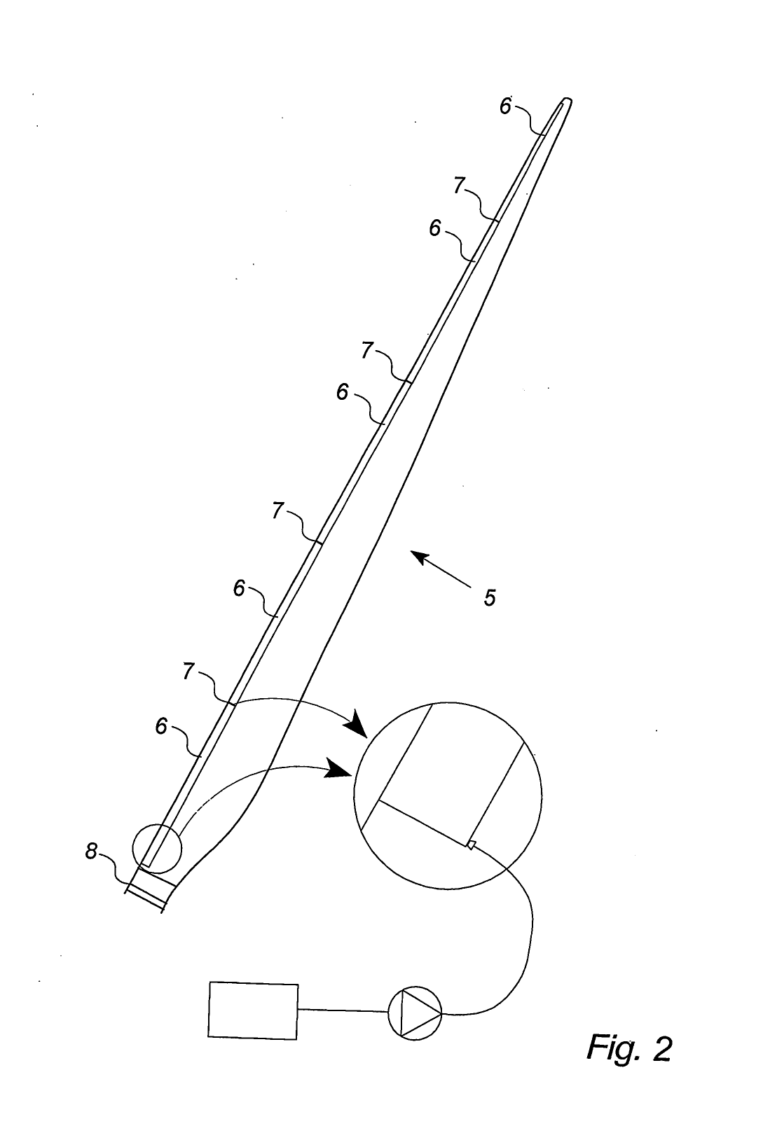

FIG. 2 illustrates a preferred embodiment of a wind turbine blade 5 including a number of front covers 6 arranged on the part of the blade that usually have the front in direction of the wind during use.

The front covers 6 are arranged end to end establishing joints 7 in which the ends may be directly or indirectly connected to each other or just arranged closely.

As illustrated in the figure, the first front cover may start at the root of the wind turbine blade and the last cover end at the tip of the blade, creating a continuous line of front covers each covering a section of the blade. However, the front covers may also start and end at other positions, e.g. start and end at some distance from the root and the tip.

Further, one or more front covers may cover different sections of the wind turbine blade, e.g. a section at the centre and the root of the blade with an uncovered section in between or simply one front cover covering one section of the blade.

The front covers 6 are preferably adapted to form an aerodynamic profile with the wind turbine blade 5 in relation to the wind.

The different front covers are adapted to the section of the wind turbine blade that they cover. Especially, the widths of the covers vary in order to meet the different dimensions of the wind turbine blade at different positions e.g. the width at the root compared to the width at the tip. The height of the front covers, and thus the side-to-side length of the covers, also varies in order to meet the above-mentioned different dimensions of the wind turbine blade.

It shall be emphasized that the wind turbine blade may also be covered by one single front cover adapted to the wind turbine blade in its full length or at least a large part of it.

In a preferred embodiment the front covers are adhered to the wind turbine blade.

The sectional view of the figure illustrates a pumping system pumping adhesive means comprising a high fluidity in between the front covers and the wind turbine blade. The pumping system is illustrated in a basic form with a pump and a container holding the adhesive means. The system may, however, comprise further means such as control means ensuring that the adhering means is applied in sufficient quantity, e.g. by measuring the delivered quantity or by measuring the pressure in the adhering means.

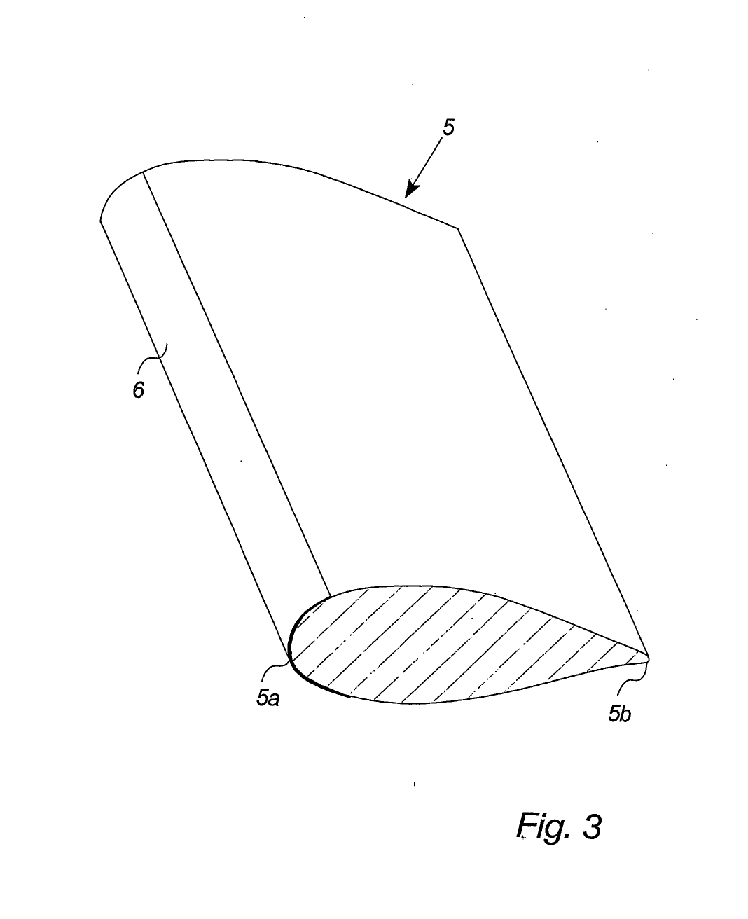

FIG. 3 illustrates a sectional view of the preferred embodiment in FIG. 2.

The figure especially illustrates the leading 5a and rear or trailing edge 5b of a wind turbine blade 5 in which the leading edge of the blade is covered with a front cover 6.

It shall be emphasized that the wind turbine blade may also be covered by rear covers adapted to the trailing edge of the wind turbine blade or even covers adapted to cover parts of the blade not including the leading or trailing edges. However, the desired behavior of the wind makes it especially advantageous to use the invention in connection with the front part of the wind turbine blade.

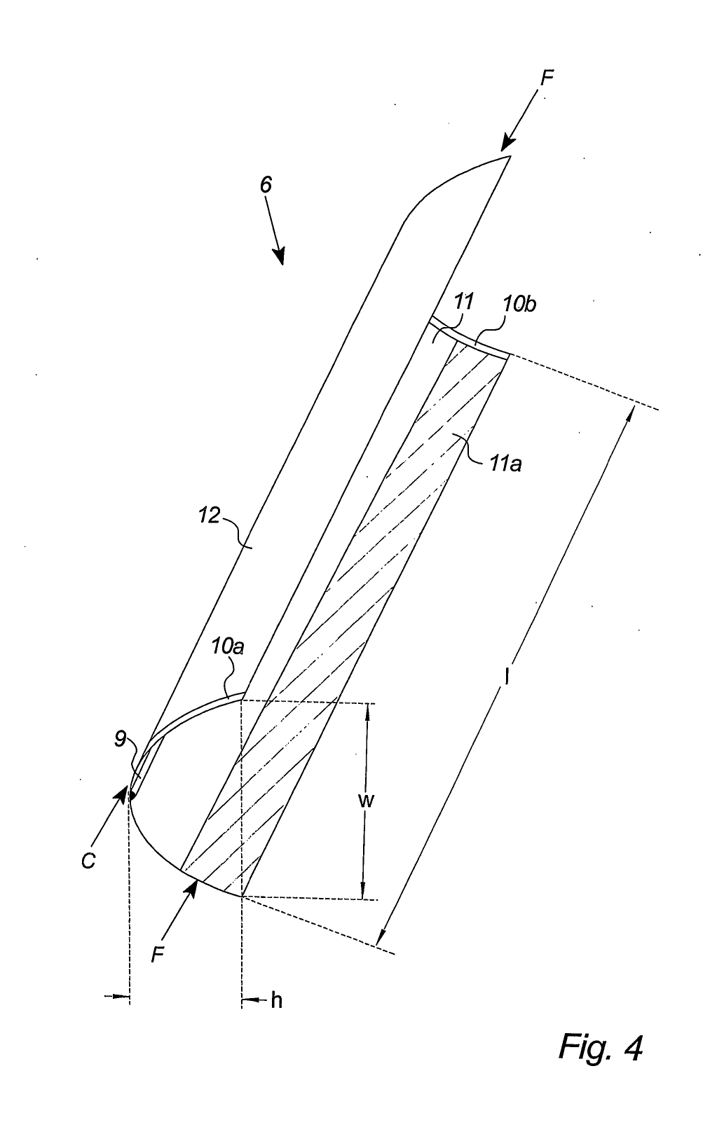

FIG. 4 illustrates in details a preferred embodiment of a front cover 6 according to the invention.

The front cover 6 comprises a centre section C and two flap sections F. The centre and flap sections together form the front cover adapted to the shape of the wind turbine blade.

The flap sections are defined as the sides of the cover and are preferably more flexible than the centre section allowing the flap sections to be bend toward the sides of the wind turbine blade.

In the present embodiment the front cover comprises a section of a rather circular shape but may comprise other elliptical shapes with axes of different lengths e.g. a narrow egg shape or a wider dome shape corresponding to the shape of different parts of the wind turbine blade.

The front cover preferably comprises a width and height ranging between 0.02 and 0.2 metre in width and between 0.05 and 0.2 metre in height, corresponding to the shape of different parts of the wind turbine blade.

The front cover 6 includes an inner 11 and outer surface 12. From the inner surface distance means expands 9 in form of an elevation in the longitudinal direction of the front cover. However, the characteristics of the distance means of a front cover may be varied, e.g. in direction, number and size, as will be further explained in the following text and corresponding drawing.

The inner surface of the front cover at the flap sections may also comprise an adhesive layer 11a (illustrated as a hatched area on one flap section) extending from end to end of the front cover.

The layer may cover the flap section parts partly or totally. In a preferred embodiment the adhesive layer is between 10 and 100 millimetres such as 50 millimetres.

Further, the inner surface comprises an inner area at one end of the front cover establishing an inner edge or rim 10b. Similarly the outer surface 12 of the front cover comprises an outer area with an outer edge or rim 10a but at the opposite end of the cover.

In a preferred embodiment the front cover has a cover thickness range between 0,1 and 5 millimetres preferably between 0.5 and 1.5 millimetres e.g. 0.5 millimetre at or close to the ends of the cover flap sections and 3 millimetres at the centre of the front cover.

The ends may advantageously be rounded in order to establish a smoother crossing to the wind turbine blade.

The distance from the frontage of the front cover to the leading edge of the wind turbine blade may preferably be between 2 and 10 millimetres such as between 4 and 6 millimetres. With a distance of 5 millimetres and a centre cover thickness of 1.5 millimetres the maximum height of the space is—largely—3 millimetres, which is considered advantageously.

Further, the cover length may range between 1 and 100 metres preferably between 1 and 5 metres such as 2 metres.

Even further, the figure illustrates with arrows and dotted lines the height h, the length l and the width w of the front cover.

FIG. 5a to 5d illustrate the linking between several front covers including different examples of connections between opposite edges of the covers.

FIG. 5a illustrates two front covers 6 arranged end to end and thus establishing a joint 7.

Further, the front covers illustrate a different embodiment of the invention, as the covers comprise two distance means 9a, 9b instead of just one. The distance means of the embodiment is positioned on opposite side of the centreline of the centre section e.g. symmetrically positioned in relation to the centreline.

FIG. 5b to 5d illustrate embodiments of the joint between the front covers in sectional views in which an end of the first front cover is positioned next to an end of the second cover.

FIG. 5b illustrates an embodiment in which the front covers comprise inner and outer edges or rims 10a, 10b with lesser material thickness. The lesser thickness may be in form of incisions of the inner and outer surface, respectively. The incisions fit to each other, e.g. by having a common thickness corresponding to the general thickness of the rest of the front cover, allowing them to overlap from one front cover to the next.

The overlap may in itself act as a closure of the joint between the two front covers but may also be further sealed, e.g. by adhesive means positioned on the two meeting surfaces of the inner and outer edges or rims 10a, 10b.

FIG. 5c illustrates the embodiment of FIG. 5b with a lip on each end of the inner and outer edge or rim 10a, 10b. Each lip engages with the corresponding edge or rim, locking the two front covers to each other.

FIG. 5d illustrates a further embodiment in which two ends of the front covers are positioned next to each other. The front covers are connected by an adhesive tape or strip 10c that also closed the joint 7.

In a basic embodiment of the joint 7 between two front covers the ends meet or are at least close to each other but without making a connection. The basic embodiment may be seen as FIG. 5d without the adhesive tape or strip.

Even further, the figure illustrates with arrows and dotted lines the material thickness t of the front cover.

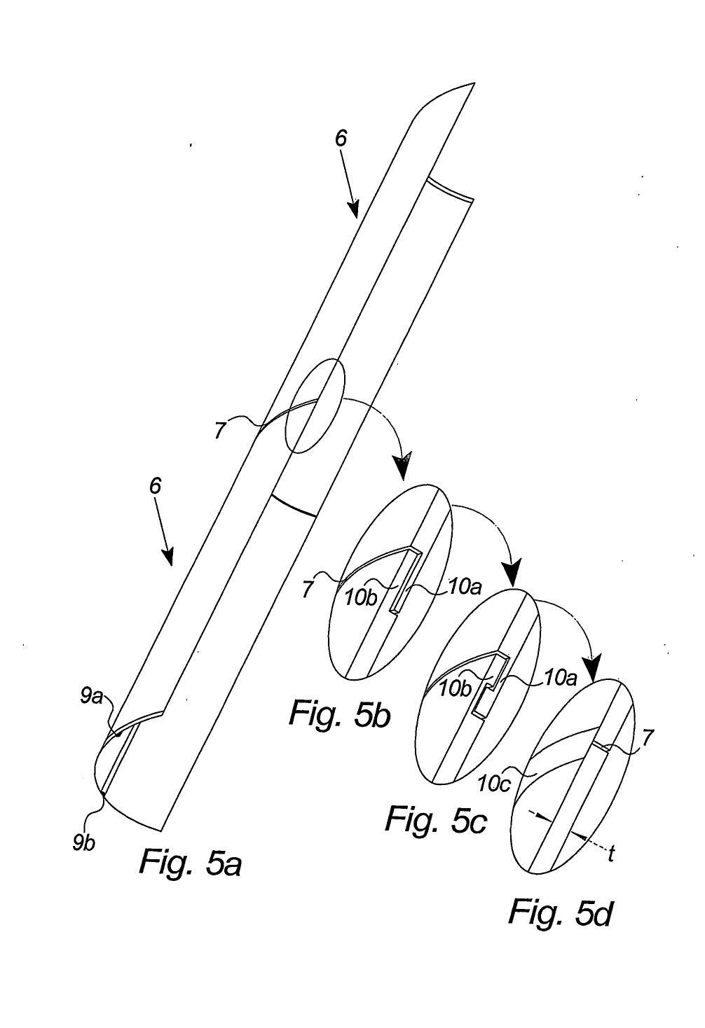

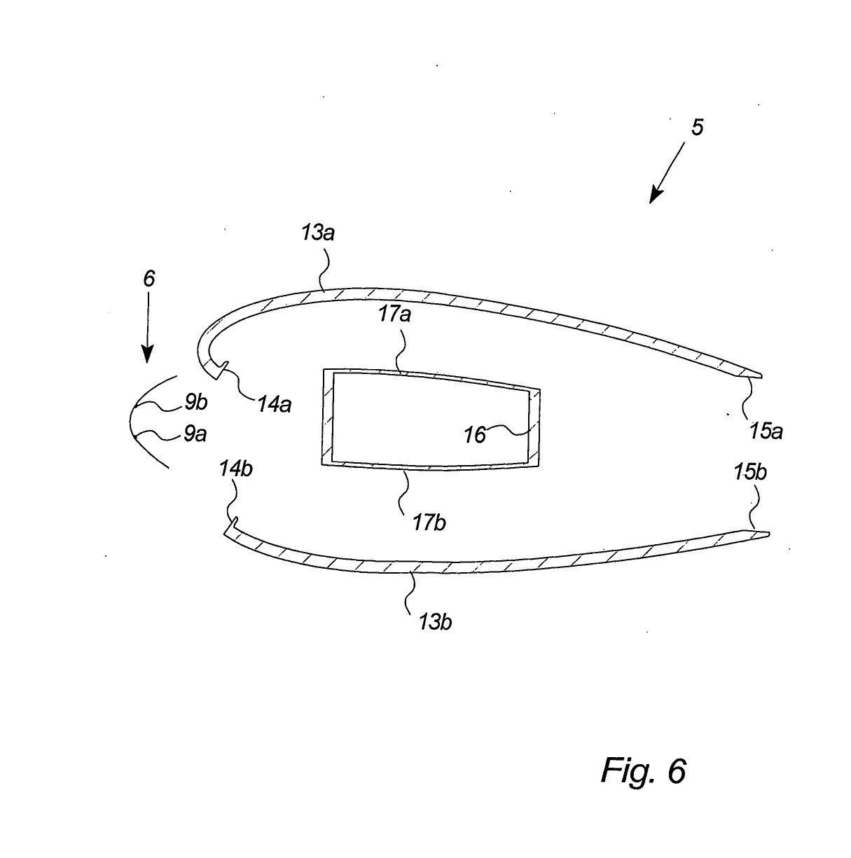

FIG. 6 illustrates an exploded view of a preferred embodiment of a wind turbine blade including front covers according to the invention.

The wind turbine blade includes a first and second blade shell 13a, 13b fastened to each other along at least two substantially longitudinal joints. The leading joint 14a, 14b is illustrated with two prolonged fastening surfaces to receive the adhesive means fastening the blade shells together at the front. Further, the trailing longitudinal joint 15a, 15b is illustrated with two fastening surfaces to receive the adhesive means fastening the blade shells together at the rear.

The wind turbine blade also comprises a load bearing beam structure 16. The beam comprises an upper and lower beam surface 17a, 17b being mutually connected by two perpendicular plates.

The wind turbine blade shells and beam may be made in glass fibre reinforced plastics (GRP) i.e. glass fibre reinforced polyester or epoxy. However, other reinforcing materials may be used such as carbon fibre or aramid (Kevlar). Wood, wood-epoxy, wood-fibre-epoxy or similar composites may also be used as wind turbine blade materials.

The upper and lower beam surfaces are covered with adhesive means before being positioned in between the shells. After the positioning of the beam the shells are assembled and adhered to each other and the surfaces of the beam establish a wind turbine blade with the necessary strength and rigidity to be part of a modern wind turbine.

The shells are illustrated in different shapes or sizes resulting in a leading joint below a longitudinal diametrical plane of the wind turbine blade. However, it shall be emphasized that the leading and trailing joints may be anywhere in the front or rear section of the blade, respectively, and the corresponding front cover may be modified to correspond with the position of the joint—if necessary.

The centreline of the front cover preferably corresponds with the joint and longitudinal diametrical plane of the wind turbine blade. However, in other embodiments one or more of the centreline, the joint and longitudinal diametrical plane may be spaced apart as long as the front cover covers the joint in particular.

After the assembly of the shells the front covers 6 including the distance means 9a, 9b may be positioned and fastened to the wind turbine blade ending the manufacturing of a wind turbine blade according to the invention.

The front cover may be made of a number of materials or combinations of materials by several production methods.

However, in a preferred embodiment the cover is made in plastic by an injection moulding machine.

In another embodiment casting in a mould is used to create the front cover in glass fibre material or a similar fibre material such as carbon fibre or aramid material reinforcing an epoxy or polyester resin.

Further, the front cover may be manufactured in a thin metal plate e.g. in a rolled metal with the distance means welded or adhered to the plate. The metals are preferably chosen among the lighter metals such as aluminium.

The front cover may also be made of different materials such as a plastic plate with rubber distance means.

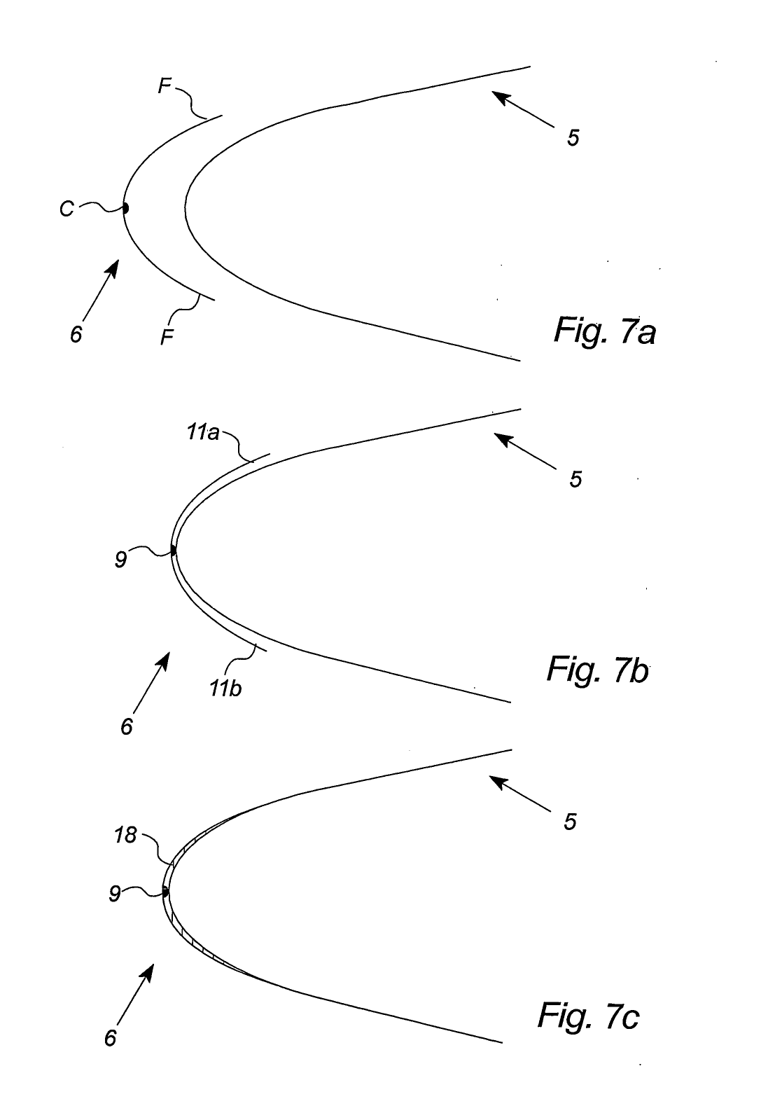

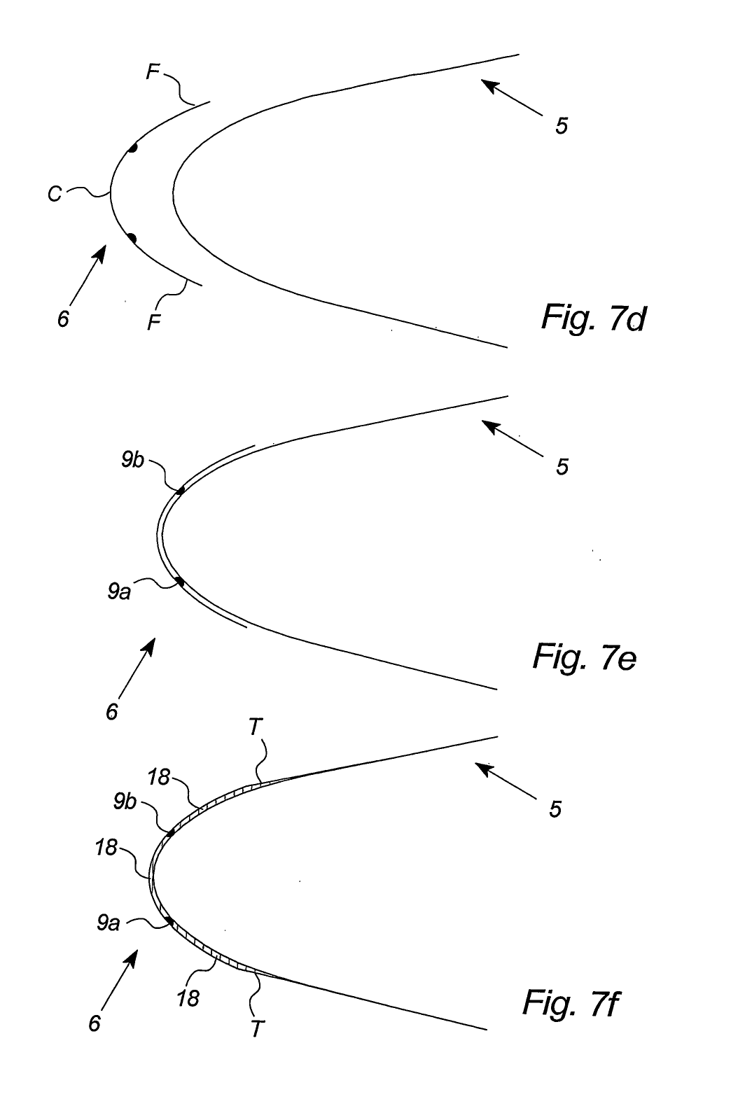

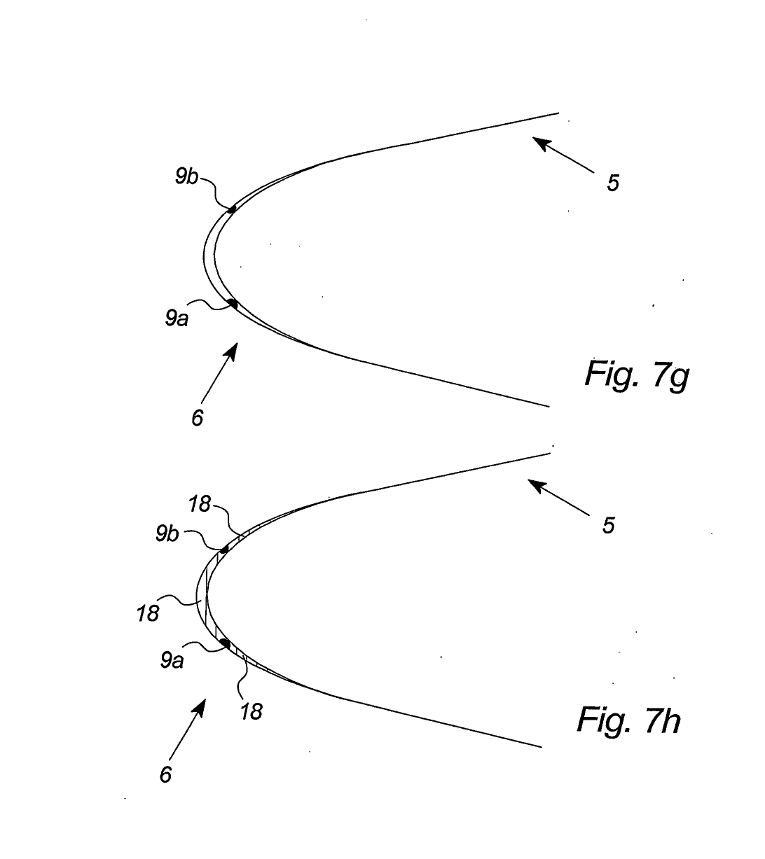

FIGS. 7a to 7h illustrate three different methods of manufacturing a wind turbine blade including different embodiments of the front covers according to the invention

FIGS. 7a to 7c illustrate a first method of manufacturing a wind turbine blade including a first embodiment of a front cover according to the invention.

The front cover 6 corresponds to the front cover of FIG. 4 with one distance means 9 positioned at the middle of the centre section C. Further, the front cover comprises two flap sections F with an adhesive layer 11a, 11b on the inner surface.

FIG. 7a illustrates the front of the wind turbine blade 5 and the front cover positioned opposite each other.

FIG. 7b illustrates how the distance means 9 initially meet the front of the wind turbine blade. The surface of the distance means may in an embodiment include adhesive means establishing a first connection between the front cover and the wind turbine blade.

It is further illustrated that the flap sections do not connect with the sides of the wind turbine blade as they extend in a wider angle than the blade shape. However, the extension angle may also be less than the blade requiring that the front cover be forced onto the blade by expanding the flap sections further out.

By the expansion of the flap sections against the sides of the wind turbine blade, an enclosure of the space beneath the front cover is established. This is especially possible if the surface of the distance means includes adhesive means establishing a first connection between the front cover and the wind turbine blade.

FIG. 7c illustrates connection of the flap sections to the sides of the wind turbine blade with use of the adhesive layers 11a, 11b on the inner surface of the front cover.

With the connection of the flap sections to the wind turbine blade a space between the front cover and the blade is established. The space is closed at the sides by the adhesive layer 11a, 11b and at the crossings between the front covers by one or more of the embodiments described above, e.g. adhesive tape or strip. Further, the opening at the first and last front cover may be closed with closing means such as adhesive tape or strip, expanding foam, silicone mass or the like.

The length of the distance means 9 determines the size of the space.

After the closure of the space the space is filled with an adhesive means in form of a adhesive mass comprising a high fluidity in order to be easy pumpable by a pumping system. The mass will after solidification fixate the front cover to the wind turbine blade, establishing a solid cover of the front part of the blade including the joint between the shells.

The adhesive mass may preferably be chosen among one-component or two-component adhesives such as epoxy, polyurethane or methacrylate adhesives.

Other adhesives may however be used in order to permanently bond the front cover to the wind turbine blade.

The space may in one embodiment be filled from a filling hole e.g. at the opening between the first front cover and the wind turbine blade at the root of the blade by a pumping system as described in connection with FIG. 2.

In a further embodiment the root filling hole may be complemented with holes at some front covers or even each front cover e.g. in form of filling holes in the crossings between the front covers. Hereby, the space may be filled more efficiently e.g. by a pumping system as described in connection with FIG. 2.

A variation over the basic embodiment, in which the ends of the covers simply meet without any closure, may be to add a material such as expanding foam, silicone mass or the like. The material will close the ends of the front cover and with the side closures, e.g. the adhesive layers 11a, 11b, an enclosed space will be established underneath the front cover. This space may be filled with an adhesive mass through a hole in the closure.

FIGS. 7d to 7f illustrate a second method of manufacturing a wind turbine blade including a second embodiment of a front cover according to the invention.

FIG. 7d illustrates a front cover comprising two symmetrically positioned distance means 9a, 9b but not comprising adhesive layers on the inner surfaces of the flap sections F.

FIG. 7e illustrates the positioning of the front cover on the front of the wind turbine blade. With adhesive means on the distance means it is possible to arrange the front cover in a stable position on the wind turbine blade.

FIG. 7f illustrates the closing of the space underneath the front cover with a line of tape T connecting the outer surface of the front cover and the side of the wind turbine blade. The space is filled with an adhesive mass 18 after the closure of the sides with tape and the crossings between the front covers—as described above—have been established.

FIGS. 7g and 7h illustrate a third method of manufacturing a wind turbine blade including a third embodiment of a front cover according to the invention.

FIG. 7g illustrates a front cover comprising two symmetrically positioned distance means 9a, 9b and adhesive layers on the inner surfaces of the flap sections F. The flap sections are forced to meet the sides of the wind turbine blade by bending the front cover over the two distance means before being filled with the adhesive mass 18 (as illustrated in FIG. 7h).

It shall be emphasized that the space closure may comprise a number of holes, in addition to the filling holes, such as holes ventilating the adhesive mass during the curing. The holes may be closed at a following aftertreatment of the wind turbine blade.

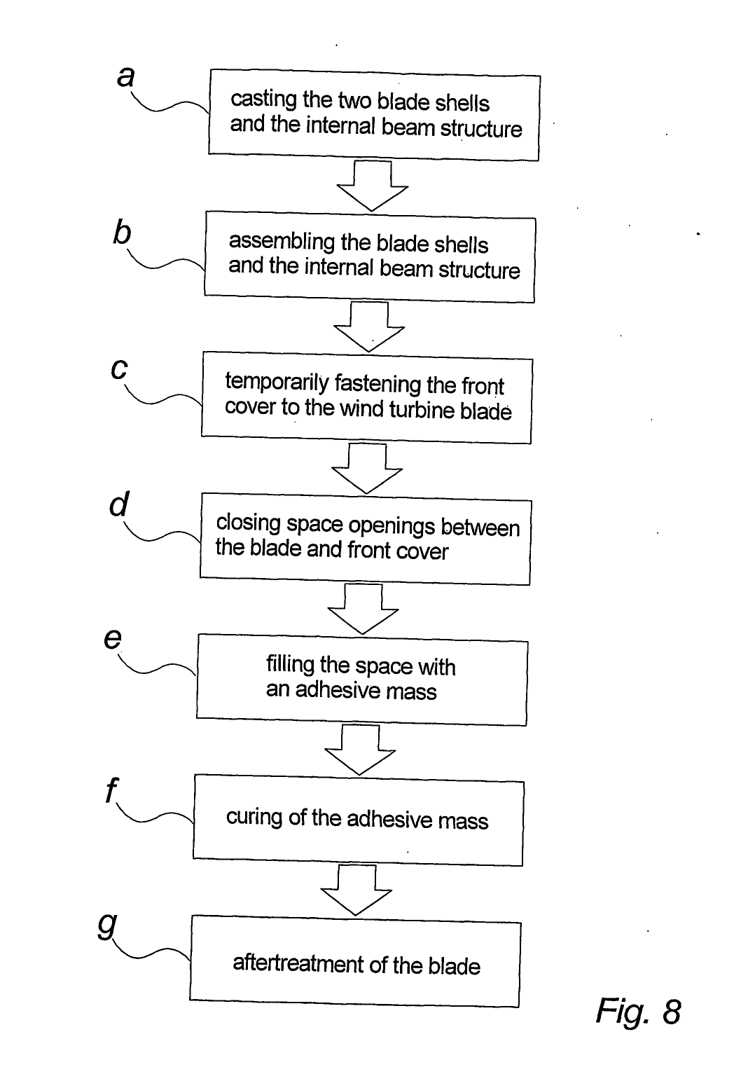

FIG. 8 illustrates a flow chart of the manufacturing of a wind turbine blade including a preferred embodiment of a front cover according to the invention.

The manufacturing method includes the steps:
a) Casting the two blade shells and the internal load bearing beam structure.
b) assembling the blade shells and the internal load bearing beam structure with adhesive means.
c) temporarily fastening the front cover to the wind turbine blade e.g. by adhesive means on the distance means.
d) closing space openings between the wind turbine blade and the front cover or at the crossings between front covers e.g. by using adhesive layers or tapes.
e) filling the enclosed space with an adhesive mass e.g. through one or more filling holes.
f) curing of the adhesive mass e.g. by applying heat in order to elevate the temperature and thus enhance the curing process.
g) aftertreatment of the wind turbine blade such as removing any excessive adhesive mass and closing ventilation and filling holes.

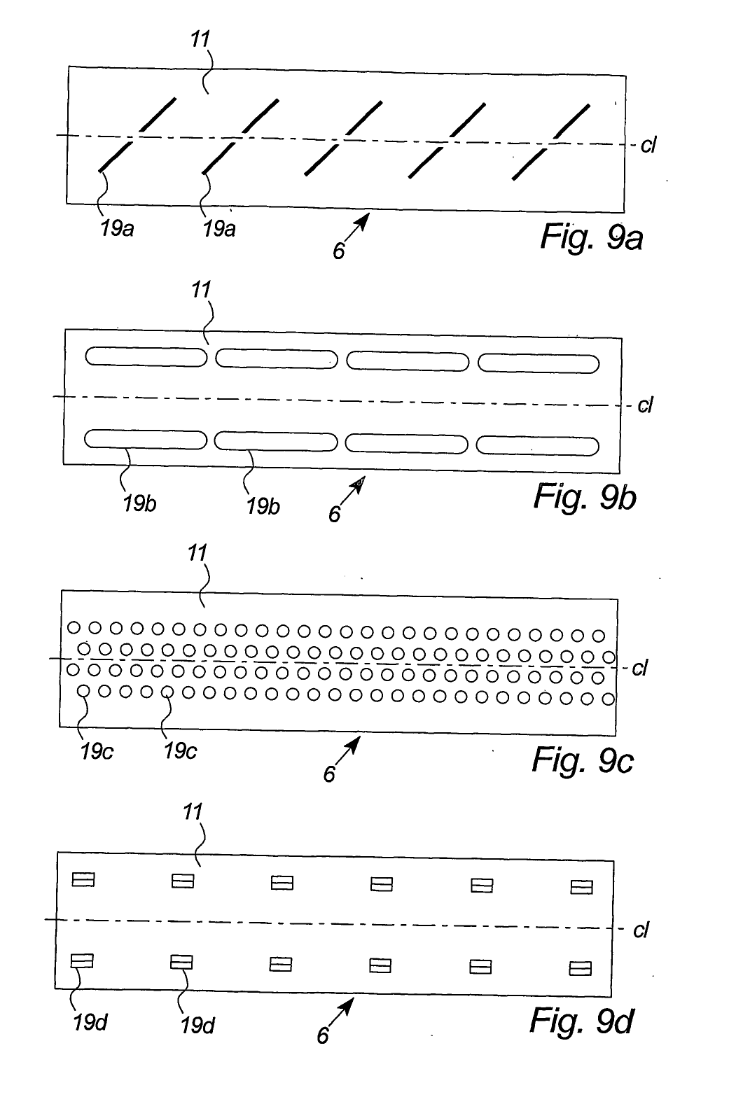

FIGS. 9a to 9d illustrate embodiments of the inner surface of the front cover with different patterns and shapes of distance means. The embodiments are each illustrated as a section of the inner surface with a centreline cl but without the curving of the surface. The centreline preferably corresponds substantially to the longitudinal joint of the wind turbine blade e.g. the leading joint.

FIG. 9a illustrates a first embodiment in which the distance means 19a is angled in relation to the centreline cl. The angle may be anywhere between nil (substantially match the embodiment of FIG. 4 and FIGS. 7a to 7c) and 90 degrees but is illustrated in present embodiment as 45 degrees. The distance means comprises a number of elevations shaped as thin and oblong banks. The inner surface also comprises openings between the banks and particularly at the centreline. The openings allow the adhesive mass to expand more freely to every corner of the enclosed space.

In a variation of the embodiment the banks are angled differently e.g. every other is angled 45 degrees and every other 90 degrees. Further, more or less openings are possible.

FIG. 9b illustrates an embodiment largely corresponding to the distance means of e.g. FIG. 5a but with openings creating a number of distance means 19b or elevations shaped as thick and oblong banks being parallel to the centreline.

FIG. 9c illustrates an embodiment comprising a large number of hemispherical shaped distance means 19c. The distance means is illustrated as being positioned in a symmetrical pattern in which the pattern may be configured with many or few distance means. Further, the size of the distance means may vary e.g. from the centreline and outwards by continuously decreasing the size and thus matching the shape of the wind turbine blade.

FIG. 9d illustrates an embodiment comprising a number of cone-shaped distance means 19d positioned symmetrically around the centreline. The cone tips may engage with the surface of the wind turbine blade with a lesser and more defined area than the embodiments of FIGS. 9a to 9c that end in more rounded tips.

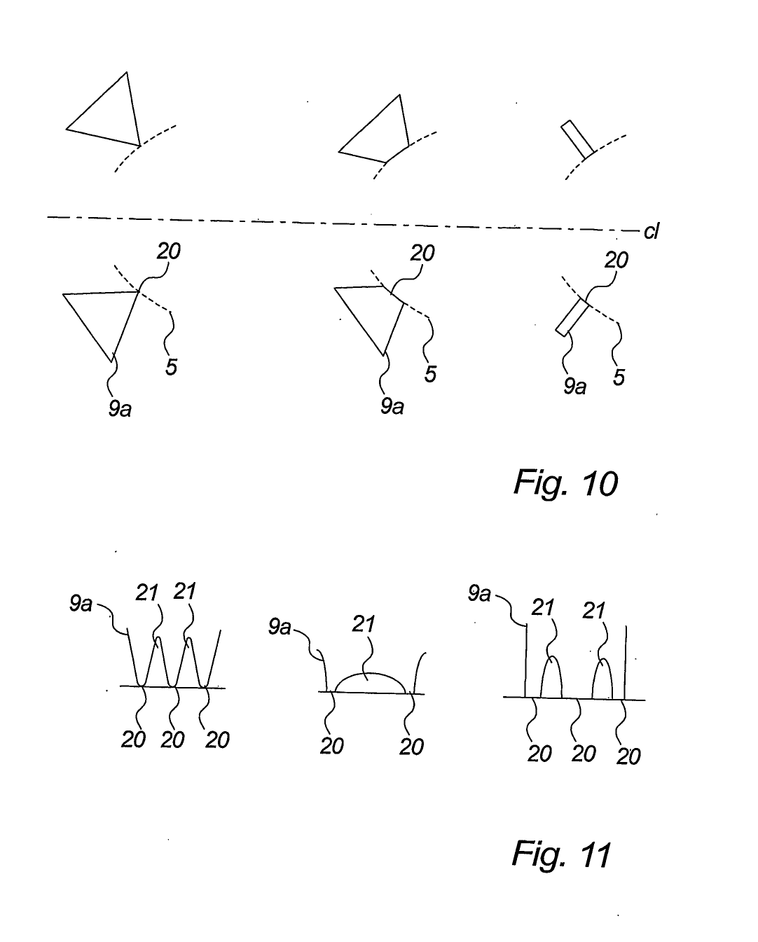

FIG. 10 illustrates different cross sections of the distance means 9a around the centreline cl.

The first embodiment illustrates the cone-shaped distance means 9a of FIG. 9d engaging with the surface of the wind turbine blade 5.

The second embodiment may illustrate the cone-shaped distance means 9a of FIG. 9d engaging with the surface of the wind turbine blade 5 in which the distance means is made in a rather soft material allowing the distance means to be squeezed together when meeting the blade.

However, the embodiment may also illustrate distance means being shaped as a truncated cone allowing a larger contact surface area.

The last embodiment illustrates the distance means as having a more unvarying profile e.g. a triangular, rectangular or cylindrical shape.

FIG. 11 illustrates different embodiments of distance means 9a in connection with the surface of the wind turbine blade 5. The distance means all comprise contact surfaces 20 with the turbine blades. The distance means is divided creating channels or openings 21 between the contact surfaces of the distance means and the blade for the adhesive mass to enter.

The first two embodiments illustrate the possibility of one large or two smaller channels of the tips in which the distance means sharpens toward the contact surface 20. The last embodiment illustrates a more unvarying profile of the distance means, e.g. a triangular, rectangular or cylindrical shape.

Beside the shapes, patterns and configurations of distance means illustrated in FIGS. 9a to 9d, FIG. 10 and FIG. 11, the distance means may comprise other shapes and be configured in other patterns that are advantageous in relation to the assembly with the wind turbine blade e.g. combinations of the content in FIGS. 9a to 9d, FIG. 10 and FIG. 11 such as cone-shaped bars etc.

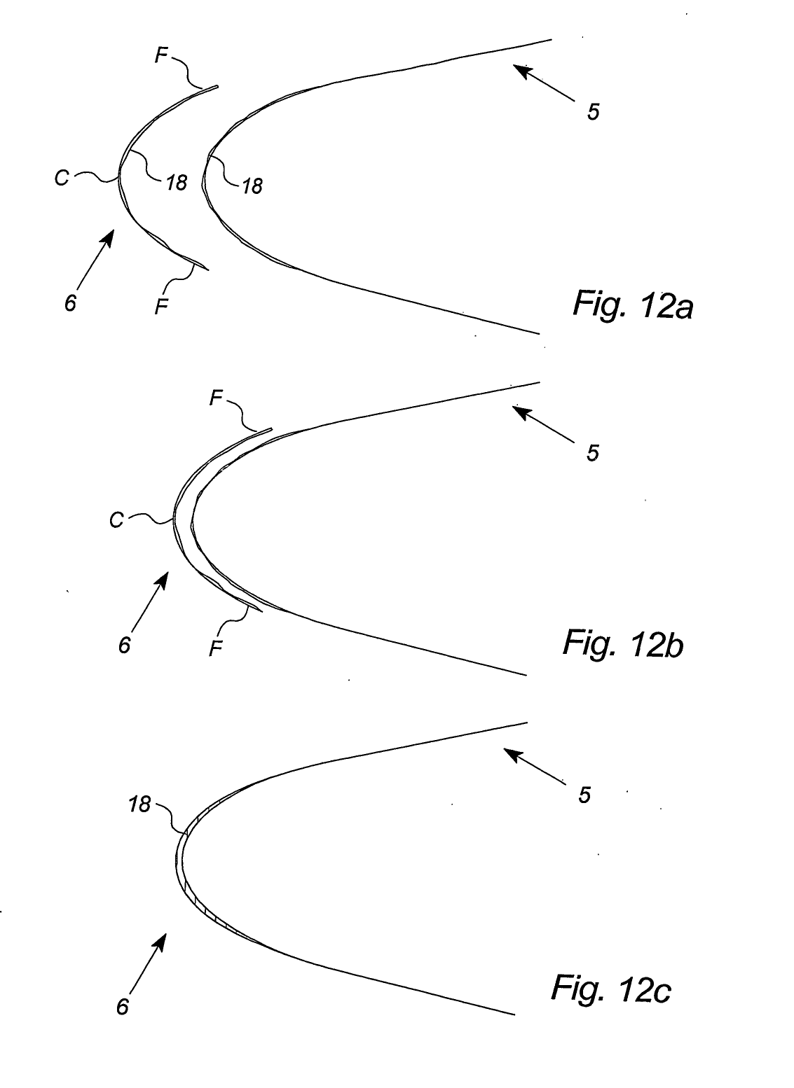

In another preferred embodiment of the invention the front cover is pre-formed to a shape substantially corresponding to a wind turbine blade or sections hereof but without any distance means as illustrated in FIGS. 12a to 12c i.e. the inner and outer surface being smooth or substantially smooth.

The inner surface of the front cover and the corresponding section of the wind turbine blade are covered with adhesive means 18 and brought together in a solid bonding, i.e. without air bubbles or blisters.

Embodiments in which the front cover or the wind turbine blade is solely covered with adhesive means before bonding are also feasible.

The solid bonding may be enhanced by applying force to the front covers e.g. with clamps or the like.

After the bonding any additional adhesive means expanding out from the front cover, e.g. at the sides or ends, are removed. The removal is preferably performed before the curing of the adhesive means is fully completed.

The adhesive means may preferably be chosen among one-component or two-component adhesives such as epoxy, polyurethane or methacrylate adhesives.

Other adhesives may however be used in order to permanently bond the front cover to the wind turbine blade.

The invention has been exemplified above with reference to specific examples. However, it should be understood that the invention is not limited to the particular examples described above but may be used in connection with a wide variety of applications. Further, it should be understood that especially the wind turbine blade and the front cover according to the invention may be designed in a multitude of varieties within the scope of the invention as specified in the claims.

### LIST

1. Wind turbine
2. Wind turbine tower
3. Wind turbine nacelle
4. Wind turbine hub
5. Wind turbine blade
5a. Front or leading edge of a wind turbine blade
5b. Rear or trailing edge of a wind turbine blade
6. Front cover for a wind turbine blade
7. Joint between front covers
8. Root of wind turbine blade
9, 9a, 9b. Distance means
10a, 10b. Inner and outer edge or rim
10c. Adhesive tape or strip
11. Inner surface of front cover
11a, 11b. Adhesive layer on the inner surface
12. Outer surface of front cover
13a, 13b. Wind turbine blade shells
14a, 14b. Leading longitudinal joint surface of wind turbine blade shells
15a, 15b. Trailing longitudinal joint surface of wind turbine blade shells
16. Load bearing beam structure
17a, 17b. Upper and lower beam surface for applying adhesives
18. Adhesive means such as an adhesive mass
19a-19d. Different shaped distance means
20. Contact surface
21. Channels or openings for adhesives
a-g. Flow diagram blocks
h, l, w, t. Height, length, width and thickness of the front cover
cl. Centreline
C. Centre section of the front cover
F. Flap sections of the front cover
T. Tape or strip

1. Method of manufacturing a wind turbine blade, said method comprising the steps of:
casting at least two wind turbine shells and preferably one or more load bearing structures,
forming a wind turbine blade structure including at least two longitudinal joints by adhering said at least two wind turbine shells and said one or more load bearing structures together,
forming one or more front covers to a shape substantially corresponding to said wind turbine blade structure or sections hereof,
positioning said one or more front covers in relation to said wind turbine blade structure, and
fastening said one or more front covers to said wind turbine blade structure with adhering means.

2. Method according to claim 1 wherein said one or more covers are positioned above one of said at least two longitudinal joints or a section hereof.

3. Method according to claim 1, wherein said adhering means is applied to an inner surface of said one or more front covers and to one or more corresponding sections of said wind turbine blade structure before fastening said one or more front covers to said wind turbine blade structure.

4. Method according to claim 1, wherein said fastening comprises the steps of: provisionally fastening said one or more front covers to said wind turbine blade structure, closing one or more space openings between said one or more front covers and said wind turbine blade structure or mutually between two or more of said one or more front covers, and filling said space with adhesive means in a form of an adhesive mass.

5. Method according to claim 4, wherein said space is created by using distance means expanding from an inner surface of said one or more front cover.

6. Method according to claim 4, wherein said closing of space openings involves positioning of internal or external adhering means at longitudinal and/or transverse edges of said one or more front covers.

7. Method according to claim 4, wherein said closing involves engaging or locking adjacent front covers to each other.

8. Method according to claim 1, wherein silicone mass, expander foam or the like is used to close openings between the front cover and the wind turbine blade or between the adjacent front covers.

9. Method according to claim 1, wherein said adherent means is applied or injected as a mass with a high fluidity at time of injection.

10. Wind turbine blade comprising at least two blade shells fastened to each other along at least two substantially longitudinal joints, comprising:
one or more front covers which covers the surface of said blade or sections thereof and is adhered to the surface with adhesive means,
wherein said one or more front covers being pre-formed to a shape substantially corresponding to said wind turbine blade or sections thereof.

11. Wind turbine blade according to claim 10, wherein said one or more front covers partly or totally cover one or more of said at least two substantially longitudinal joints.

12. Wind turbine blade according to claim 10, wherein one or more distance means expand from an inner surface of said one or more front covers and adhesive means fill a space between said one or more front covers and said wind turbine blade.

13. Wind turbine blade according to claim 12, wherein said adhesive means is a mass with high fluidity at a time of application or injection.

14. Wind turbine blade according to any of claim 10, wherein said adhesive means is a one or two-component adhesive comprising at least one of epoxy, polyurethane or methacrylate adhesives.

15. Wind turbine blade according to claim 10, wherein said front covers continuously or substantially cover said blade from root to tip.

16. Wind turbine blade according to claim 10, wherein an end of the front covers overlap.

17. Wind turbine blade according to claim 16, wherein said front cover ends comprise engaging or locking means including an inner and outer edge or rim and/or adhesive means.

18. Wind turbine blade according to claim 10, wherein tape or strips connect and close adjacent ends of the front covers or crossings between said ends.

19. Front cover comprising a center section and at least two cover flap sections, wherein said front cover partly or totally is pre-formed to a shape substantially corresponding to a wind turbine blade or sections hereof.

20. Front cover according to claim 19, wherein said cover adequately or substantially covers one or more longitudinal joints of said wind turbine blade or sections thereof.

21. Front cover according to claim 20, wherein said cover adequately or substantially covers a leading joint of said wind turbine blade.

22. Front cover according to claim 19, wherein inner and outer surfaces of said cover are smooth or substantially smooth.

23. Front cover according to claim 19, wherein an inner surface of said cover comprises one or more distance means.

24. Front cover according to claim 23, wherein ends of said one or more distance means are pre-defined to a shape corresponding to a shape a leading edge of said wind turbine blade.

25. Front cover according to claim 23, wherein said one or more distance means are positioned symmetrically in relation to one or more longitudinal joints of said wind turbine blade.

26. Front cover according to claim 23, wherein said one or more distance means comprise shapes of oblong bars, cones, triangles, rectangles, cylinders, hemispheres or other similar shapes.

27. Front cover according to claim 23, wherein said one or more distance means comprise patterns of distance means including symmetrically positioned distance means in relation to a centerline of the front cover or one or more longitudinal joints of said wind turbine blade.

28. Front cover according to claim 23, wherein said one or more distance means comprise patterns of distance means including different shaped distance means.

29. Front cover according to claim 19, wherein a front cover thickness ranges between 0.1 and 5 millimeters.

30. Front cover according to claim 19, wherein a cover length ranges between 1 and 100 metres.

31. Front cover according to claim 23, wherein said distance means comprise a length between 0.5 and 8 millimeters.

32. Front cover according to claim 19, wherein said cover comprises a width and height corresponding to the blade shape ranging between 0.1 and 5 meters in width and between 0.1 and 2 meters in height.

33. Front cover according to claim 19, wherein said front cover is made in glass fiber material or a similar fiber material comprising carbon or aramid fibre material reinforcing an epoxy or polyester resin, plastic material or combinations of the mentioned materials.

34. Front cover according to claim 19, wherein said front cover is made in a metal plate material comprising aluminium or similar light metal plates with welded or adhered distance means.

35. Front cover according to claim 19, wherein an inner surface of said front cover and an inner surface of said at least two cover flap sections comprise at least one adhesive layer.

36. Front cover according to claim 35, wherein said at least one adhesive layer comprises a width in a range of 10 and 100 millimeters.

37. Front cover according to claim 19, wherein ends of the front cover comprise means for engaging or locking with an adjacent front cover comprising an inner edge or rim in one end of the cover and outer edge or rim at the other end and/or adhesive means.

38. Front cover according to claim 19, wherein ends of the front cover comprise means for engaging or locking with an adjacent front cover comprising tape or strips connecting and closing said adjacent ends or crossings between said ends.

39. Front cover according to claim 19, wherein the cover comprises a unit for supplementary mounting on a wind turbine blade.
